(19) United States
(12) Patent Application Publication
(10) Pub. No.: US 2019/0384078 A1
(43) Pub. Date: Dec. 19, 2019

(54) LIGHTING JIG FOR RETURNING TO LIGHT-ON AND PANEL DETECTING METHOD THEREOF

(71) Applicant: SHENZHEN CHINA STAR OPTOELECTRONICS SEMICONDUCTOR DISPLAY TECHNOLOGY CO., LTD., Shenzhen, Guangdong (CN)

(72) Inventor: Tianhong WANG, Shenzhen, Guangdong (CN)

(21) Appl. No.: 15/746,498

(22) PCT Filed: Jan. 12, 2018
(86) PCT No.: PCT/CN2018/072310

§ 371 Date: Jan. 22, 2018

(30) Foreign Application Priority Data
Nov. 21, 2017 (CN) 201711168949.2

(51) Int. Cl. G02F 1/13; G09G 3/00

(52) U.S. Cl. CPC G02F 1/1309; G09G 3/006

(57) ABSTRACT

The disclosure relates to a lighting jig for returning to light-on and a panel detecting method thereof. The lighting jig for returning to light-on includes a FPC and an X-board; an end of the FPC includes a bonding area configured to bond to the X-board and other end includes a bonding area configured to bond to a chip-on-film of a LC panel cutting off a cell test pad; the X-board includes a testing pad configured to connect a detection apparatus in a cell-forming stage with the FPC; the FPC includes an internal wiring. The internal wiring is configured to connect the testing pad and the chip-on-film when the FPC is simultaneously bonded to the X-board and the LC panel. The disclosure can improve the detecting yield and reduce the cost waste, and facilitate the panel at the module stage to return to the cell-forming stage for detecting.

### RELATED APPLICATIONS

The present application is a National Phase of International Application Number PCT/CN2018/072310, filed on Jan. 12, 2018, and claims the priority of China Application 201711168949.2, filed on Nov. 21, 2017.

### FIELD OF THE DISCLOSURE

The disclosure relates to the field of liquid crystal displays, and in particular to a lighting jig for returning to light-on and a panel detecting method thereof.

### BACKGROUND

The flat panel display devices such as liquid crystal display (LCD) have been widely used in mobile phones, televisions, personal digital assistants, digital cameras, notebook computers, desktop computers and other consumer electronics products and become the mainstream in the display device because of having advantages such as high quality, wide power, thin body, and wide range of application.

In the active liquid crystal display, each sub-pixel has a thin film transistor (TFT), a gate connected to the horizontal scanning line, a source connected to the vertical data line, and a drain is connected to the pixel electrode. When applying enough voltage across the horizontal scan line, it will cause all TFTs on the horizontal scan line to turn on, in this case, the pixel electrode on the horizontal scanning line will be in communication with the data line in the vertical direction, thereby writing the display signal voltage on the data line to the pixel so as to control the transmittance of different liquid crystal to achieve the effect of controlling the color. At present, the driving of the horizontal scanning lines of the active liquid crystal display panel is mainly implemented by the external IC of the panel. The external IC can control the level-by-level charging and discharging of the horizontal scanning lines at all levels. The Gate driver On Array (GOA) technology is a technology using the existing front-end array process of the thin-film transistor liquid crystal display. The gate line scanning driver signal circuit is made on the array substrate of the thin-film transistor to achieve the driving technology for the progressive line scanning on the gate.

A typical liquid crystal display has four basic processes: Array engineering, Color Filter engineering, Cell engineering, and Module engineering. The Array engineering mainly includes forming a TFT on a glass substrate by using coating, exposure, developing, etching, etc.; the Cell engineering mainly includes a liquid crystal slicing chip and injecting a liquid crystal material; and the Module process mainly includes installing driver chips, printed circuit boards, backlight modules and the like on a panel completing cutting,

In the fabricating process, LCD needs to be performed multiple inspection procedures, one of the most important inspection procedure is to perform a testing by the LC cell completing cutting, that is, detection in a cell-forming stage, so as to confirm whether the LCD cell defects exist or not. The testing process generally first inputs a testing signal to a liquid crystal panel to make the pixels appear in color, and then observes whether each pixel is good or not through the defect detecting device, and this process is called Light-on Test. Currently, the factory at the time of mass production, a chip on film bonding pad (COF bonding pad) is typically bonded by a cell test pad, and a testing signal is inputted to the liquid crystal panel by the cell test pad.

Chip On Film (COF) is composed by bonding and mounting a chip such as source driver IC or gate driver IC on a flexible printed circuit board where the wiring pattern is formed. The wiring pattern of the chip on film is generally composed of an inner lead connected to the electrode of the IC and an outer lead connected to an external circuit. In a liquid crystal display, each pixel is controlled by a gate line and a data line arranged in a crisscross pattern on a substrate, so as to display an image. The scan signal and the data signal are sent from the control IC in the liquid crystal display, and the scanning signal and the data signal are usually transmitted to the gate lines and the data lines on the substrate by using the COF. Specifically, the COF is connected to a group of fan-shaped leads on the substrate through a set of connecting leads and then to the gate lines or the data lines of the display area.

As shown in FIG. 1, which is a schematic diagram of disconnecting wiring between a cell test pad and a COF bonding pad after detection in a cell-forming stage in the prior art. During the testing of the Cell-forming stage, the cell test pad is bonded to the COF bonding pad 1 of the COF in the bonding area shown in the box of FIG. 1, the detection apparatus in the cell-forming stage can input the testing signal to the display panel by the cell test pad. During the production of the GOA products, after passing through the detection apparatus in the cell-forming stage, the liquid crystal panel may use the laser apparatus to disconnect the wiring between the cell test pad and the COF bonding pad, so as to prevent ESD (Electrostatic Discharge) from being introduced into the panel from the pad, resulting in abnormalities.

Due to the recipe of the detection machine is single, when the process fluctuates slightly or a new failure occurs, the detection machine in the cell-forming stage often cause leakage discharge (the issue is detected at the module stage) and checked(the similar issue does not occur at the module stage), resulting in yield loss, material waste, and cost loss; however at this time, the detection apparatus in the cell-forming stage often cannot complete the recipe on time because there is no sample corresponding to the issue panel to complete the detection recipe, thereby resulting in the recipe cannot be controlled on time. Since the wiring between the cell test pad and the COF bonding pad has been disconnected after the detection of the cell-forming stage, the cell-forming stage cannot be returned to perform the light-on test.

### SUMMARY

A Therefore, it is an object of the disclosure to provide a lighting jig for returning to light-on to make the panel at the module stage to return to the cell-forming stage for detecting.

Another object of the disclosure is to provide a panel detecting method of a lighting jig for returning to light-on, so as to make the panel at the module stage to return to the cell-forming stage for detecting.

In order to achieve the object, the disclosure provides a lighting jig for returning to light-on, including a flexible printed circuit board and an X-board; an end of the flexible printed circuit board includes a bonding area configured to bond to the X-board and other end of the flexible printed circuit board includes a bonding area configured to bond to a chip on film of a liquid crystal panel cutting off a cell test pad; the X-board includes a testing pad configured to connect a detection apparatus in a cell-forming stage with the flexible printed circuit board; the flexible printed circuit board includes an internal wiring, when the flexible printed circuit board is simultaneously bonded to the X-board and the liquid crystal panel, the internal wiring are configured to connect the testing pad and the chip-on-film of the liquid crystal panel.

The testing pad includes GOA signal testing pads.

The testing pad includes a data wiring testing pad.

The data wiring testing pad includes a red pixel data wiring pad, a green pixel data wiring pad, and a blue pixel data wiring pad.

On the X-board, a red pixel data wiring drawn from the red pixel data wiring pad, a green pixel data wiring drawn from the green pixel data wiring pad and a blue pixel data wiring drawn from the blue pixel data wiring pad are shorted with each other.

The disclosure also provides a panel detecting method of a lighting jig for returning to light-on, including:

Step 10: providing a flexible printed circuit board and an X-board;

Step 20: bonding a bonding area arranged on an end of the flexible printed circuit board to the X-board, and bonding a bonding area arranged on the other end of the flexible printed circuit board to the chip-on-film of the liquid crystal panel cutting off the cell test pad;

Step 30: arranging a testing pad configured to connect a detection apparatus in a cell-forming stage with the flexible printed circuit board on the X-board;

Step 40: when the flexible printed circuit board is simultaneously bonded to the X-board and the liquid crystal panel, connecting the testing pad to the chip on film of the liquid crystal panel through the internal wiring of the flexible printed circuit board.

The testing pad includes a plurality of GOA signal testing pads.

The testing pad includes a data wiring testing pad.

The data wiring testing pad includes a red pixel data wiring pad, a green pixel data wiring pad, and a blue pixel data wiring pad.

On the X-board, a red pixel data wiring drawn from the red pixel data wiring pad, a green pixel data wiring drawn from the green pixel data wiring pad and a blue pixel data wiring drawn from the blue pixel data wiring pad are shorted with each other.

The disclosure also provides a lighting jig for returning to light-on, including a flexible printed circuit board and an X-board; an end of the flexible printed circuit board includes a bonding area configured to bond to the X-board and other end of the flexible printed circuit board includes a bonding area configured to bond to a chip on film of a liquid crystal panel cutting off a cell test pad; the X-board includes a testing pad configured to connect a detection apparatus in a cell-forming stage with the flexible printed circuit board; the flexible printed circuit board includes an internal wiring, when the flexible printed circuit board is simultaneously bonded to the X-board and the liquid crystal panel, the internal wiring are configured to connect the testing pad and the chip-on-film of the liquid crystal panel;

the testing pad includes a plurality of GOA signal testing pads;

the testing pad includes a data wiring testing pad;

The data wiring testing pad includes a red pixel data wiring pad, a green pixel data wiring pad, and a blue pixel data wiring pad;

on the X-board, a red pixel data wiring drawn from the red pixel data wiring pad, a green pixel data wiring drawn from the green pixel data wiring pad and a blue pixel data wiring drawn from the blue pixel data wiring pad are shorted with each other.

In conclusion, the lighting jig for returning to light-on and the panel detecting method thereof in the disclosure can improve the testing yield and reduce the cost waste such as material, machine, and manpower; and facilitate the panel at the module stage to return to the cell-forming stage for detecting.

### BRIEF DESCRIPTION OF THE DRAWINGS

The technical proposal of the disclosure and other advantageous effects will be apparent from the following detailed description of specific embodiments of the disclosure taken in conjunction with the accompanying drawings.

In the drawings,

FIG. 1 is a schematic diagram of disconnecting wiring between a cell test pad and a COF bonding pad after testing in a cell-forming stage in the prior art;

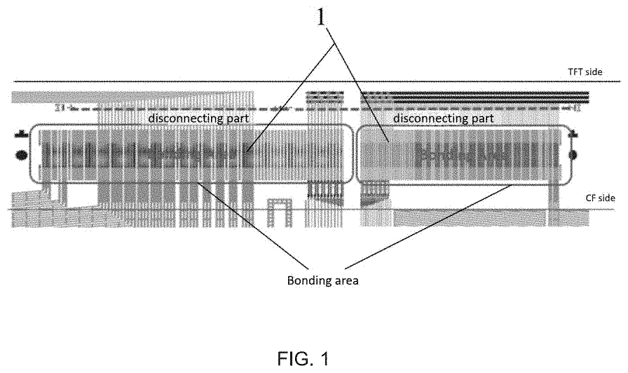

FIG. 2 is a schematic diagram of the internal connection of the lighting jig for returning to light-on after bonding according to a preferred embodiment of the disclosure;

FIG. 3 is a schematic diagram of an application of the lighting jig for returning to light-on according to a preferred embodiment of the disclosure.

### DETAILED DESCRIPTION OF PREFERRED EMBODIMENTS

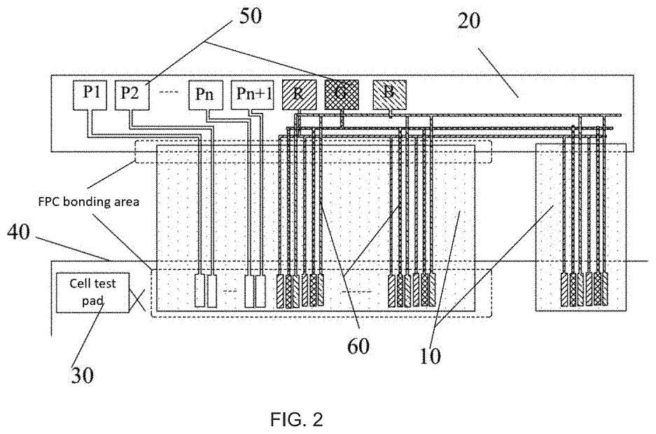

Referring to FIG. 2, which is a schematic diagram of the internal connection of the lighting jig for returning to light-on after bonding according to a preferred embodiment of the disclosure. The lighting jig for returning to light-on in the disclosure mainly includes a flexible printed circuit board 10 and an X-board 20; an end of the flexible printed circuit board includes a bonding area configured to bond to the X-board and other end of the flexible printed circuit board includes a bonding area configured to bond to a chip on film of a liquid crystal panel cutting off a cell test pad; the X-board includes a testing pad configured to connect a detection apparatus in a cell-forming stage with the flexible printed circuit board; when the flexible printed circuit board is simultaneously bonded to the X-board and the liquid crystal panel, the internal wiring are configured to connect the testing pad and the chip-on-film of the liquid crystal panel. By using the flexible printed circuit board 10 and the X-board 20 instead of the cell test pads 30, then the light-on test can be newly completed by the detection apparatus at the cell-forming stage.

The testing pad 50 may include a plurality of GOA signal testing pads, that is, the pads P1˜Pn+1. The testing pad may also include a data wiring testing pad, namely, R/G/B pads, which are a red pixel data wiring pad, a green pixel data wiring pad, and a blue pixel data wiring pad respectively. On the X-board 20, a red pixel data wiring drawn from the red pixel data wiring pad, a green pixel data wiring drawn from the green pixel data wiring pad and a blue pixel data wiring drawn from the blue pixel data wiring pad are shorted with each other; that is, on the X-board 20, the R, G, and B pads are drawn a plurality of data wiring, and are respectively shorted with each other, so as to make the connection method to be coincident as that during the general testing in the cell-forming stage.

In the disclosure, by designing a flexible printed circuit (FPC) without IC and an X board-B as a board for returning to light-on during the product design stage, which can be bonded to the liquid crystal panel and replace the cell test pad having been cut off; the disclosure is applicable to the GOA products; the disclosure can improve the testing yield and reduce the cost waste such as material, machine, and manpower.

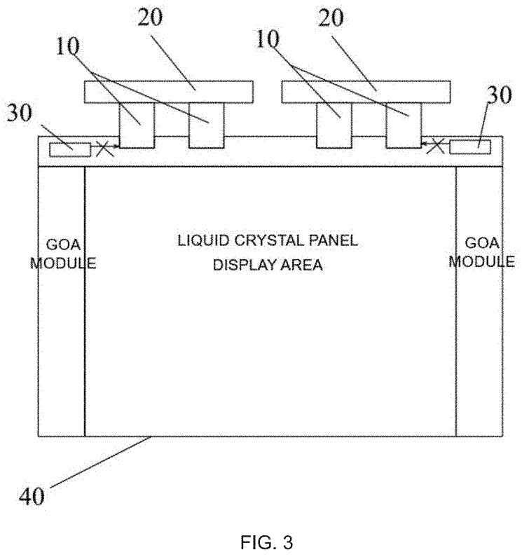

Referring to FIG. 3, which is a schematic diagram of an application of the lighting jig for returning to light-on according to a preferred embodiment of the disclosure. In the preferred embodiment, the GOA module is disposed at both the left and right sides of the liquid crystal panel display area of the liquid crystal panel 40 to perform driving so that the cell test pads 30 are formed on both sides of the liquid crystal panel 40. When performing the light-on and returning to light-on, a FPC 10 and the X-board 20 are adopted on both the left and right sides as a lighting jig for returning to light-on and are connected to the liquid crystal panel 40.

The disclosure also provides a panel detecting method of a lighting jig for returning to light-on, mainly including:

Step 10: providing a FPC and an X-board;

Step 20: bonding a bonding area arranged on an end of the FPC to the X-board, and bonding a bonding area arranged on the other end of the FPC to the chip-on-film of the liquid crystal panel cut into the cell test pad;

Step 30: arranging a testing pad configured to connect a detection apparatus in a cell-forming stage with the FPC on the X-board;

Step 40: when the FRC is simultaneously bonded to the X-board and the liquid crystal panel, connecting the testing pad to the chip on film of the liquid crystal panel through the internal wiring of the FRC.

By using the FPC 10 and the X-board 20 instead of the cell test pads 30, then the light-on test can be newly completed by the detection apparatus in the cell-forming stage.

In conclusion, the lighting jig for returning to light-on and the panel detecting method thereof in the disclosure can improve the testing yield and reduce the cost waste such as material, machine, and manpower; and facilitate the panel at the module stage to return to the cell-forming stage for detecting.

As described above, it will be apparent to those skilled in the art that various other changes and modifications may be made in accordance with the technical solutions and technical concepts of the disclosure, and all such changes and modifications are subject to be included in the scope of protection of the appended claims.

What is claimed is:

1. A lighting jig for returning to light-on, comprising:
a flexible printed circuit board; and
an X-board;
wherein one end of the flexible printed circuit board comprises a bonding area configured to bond to the X-board and other end of the flexible printed circuit board comprises a bonding area configured to bond to a chip-on-film of a liquid crystal panel for cutting into a cell test pad;
wherein the X-board comprises a testing pad configured to connect a detection apparatus in a cell-forming stage with the flexible printed circuit board;
wherein the flexible printed circuit board comprises an internal wiring, when the flexible printed circuit board is simultaneously bonded to the X-board and the liquid crystal panel, the internal wiring is configured to connect the testing pad and the chip-on-film of the liquid crystal panel.

2. The lighting jig for returning to light-on according to claim 1, wherein the testing pad comprises a plurality of GOA signal testing pads.

3. The lighting jig for returning to light-on according to claim 1, wherein the testing pad comprises a data wiring testing pad.

4. The lighting jig for returning to light-on according to claim 3, wherein the data wiring testing pad comprises a red pixel data wiring pad, a green pixel data wiring pad, and a blue pixel data wiring pad.

5. The lighting jig for returning to light-on according to claim 4, wherein on the X-board, a red pixel data wiring drawn from the red pixel data wiring pad, a green pixel data wiring drawn from the green pixel data wiring pad and a blue pixel data wiring drawn from the blue pixel data wiring pad are shorted with each other.

6. A panel detecting method of a lighting jig for returning to light-on, comprising:
Step 10: providing a flexible printed circuit board and an X-board;
Step 20: bonding a bonding area arranged on an end of the flexible printed circuit board to the X-board, and bonding a bonding area arranged on the other end of the flexible printed circuit board to the chip-on-film of the liquid crystal panel for cutting into a cell test pad;
Step 30: arranging a testing pad configured to connect a detection apparatus in a cell-forming stage with the flexible printed circuit board on the X-board; and
Step 40: when the flexible printed circuit board is simultaneously bonded to the X-board and the liquid crystal panel, connecting the testing pad to the chip-on-film of the liquid crystal panel through an internal wiring of the flexible printed circuit board.

7. The panel detecting method of a lighting jig for returning to light-on according to claim 6, wherein the testing pad comprises a plurality of GOA signal testing pads.

8. The panel detecting method of a lighting jig for returning to light-on according to claim 6, wherein the testing pad comprises a data wiring testing pad.

9. The panel detecting method of a lighting jig for returning to light-on according to claim 8, wherein the data wiring testing pad comprises a red pixel data wiring pad, a green pixel data wiring pad, and a blue pixel data wiring pad;

10. The panel detecting method of a lighting jig for returning to light-on according to claim 9, wherein on the X-board, a red pixel data wiring drawn from the red pixel data wiring pad, a green pixel data wiring drawn from the green pixel data wiring pad and a blue pixel data wiring drawn from the blue pixel data wiring pad are shorted with each other.

11. A lighting jig for returning to light-on, comprising:
a flexible printed circuit board; and
an X- board;
wherein one end of the flexible printed circuit board comprises a bonding are configured to bond to the X-board and other end of the flexible printed circuit board comprises a bonding area configured to bond to a chip-on-film of a liquid crystal panel for cutting into a cell test pad;
wherein the X-board comprises a testing pad configured to connect a detection apparatus in a cell-forming stage with the flexible printed circuit board;
wherein the flexible printed circuit board comprises an internal wiring, when the flexible printed circuit board is simultaneously bonded to the X-board and the liquid crystal panel, the internal wiring is configured to connect the testing pad and the chip-on-film of the liquid crystal panel;
wherein the testing pad comprises a plurality of GOA signal testing pads;
wherein the testing pad comprises data wiring testing pad;
wherein the data wiring testing pad comprises a red pixel data wiring pad, a green pixel data wiring pad, and a blue pixel data wiring pad;
wherein on the X-board, a red pixel data wiring drawn from the red pixel data wiring pad, a green pixel data wiring drawn from the green pixel data wiring pad and a blue pixel data wiring drawn from the blue pixel data wiring pads are shorted with each other.
